(19) United States
(12) Patent Application Publication
(10) Pub. No.: US 2026/0369174 A1
(43) Pub. Date: Nov. 19, 2026

(54) SYSTEMS AND METHODS FOR PROVIDING COMPUTER-ASSISTED TASK GUIDANCE

(71) Applicant: Adeia Guides Inc., San Jose, CA (US)

(72) Inventors: Milena Sukovic, Naples, FL (US); Jean-Yves Couleaud, Mission Viejo, CA (US); Tao Chen, Palo Alto, CA (US)

(21) Appl. No.: 19/210,496

(22) Filed: May 16, 2025

(51) Int. Cl. G09B 5/02; G06T 11/60; G06V 40/16

(52) U.S. Cl. CPC G09B 5/02; G06T 11/60; G06V 40/161

(57) ABSTRACT

Systems and methods are provided for providing computer-assisted guidance, e.g., a virtual tutorial or instructions. Guidance may be enhanced by providing real-time feedback via a user interface on a device associated with the user. According to an embodiment, a user image comprising a face of a user is obtained, and a target image comprising a reference look is obtained. A target area of the target image of the reference look is determined from a device associated with the user. A virtual tutorial for performing at least one action to the target area of the user is identified based at least in part on the user image, the target image, and the target area. The virtual tutorial is provided to the device associated with the user.

### BACKGROUND

This disclosure is directed to systems and methods for providing computer-assisted guidance, e.g., a virtual tutorial or instructions. The guidance may be enhanced by providing real-time feedback.

### SUMMARY

Computer-assisted guidance is useful in a variety of contexts to help perform tasks. Makeup application guidance, such as makeup tutorial videos provided by video providers, in-store makeup sales consultants, or private makeup application professionals, has risen in popularity over the past decade. Often, makeup tutorials are viewed on smartphones or laptops while simultaneously applying makeup with the tutorial. Generally, a physical mirror may be used with a smartphone displaying the tutorial video on the side. In some cases, the tutorial video is viewed first and there is a later attempt to replicate the instructions. It can be desirous to apply makeup while watching a tutorial video all on one device.

Some approaches may use a “smart mirror” that combines the reflective properties of a physical mirror with an integrated digital display. For instance, in some approaches, smart mirrors may have an active screen display with both a makeup tutorial video and a reflection of the user applying their own makeup. In some approaches, smart mirrors have just a holder to place a smartphone in an adequate position so that both the mirror and the smartphone are clearly visible. Approaches relying on a physical mirror with digital content display typically fail to capture image data, let alone relate contemporaneous image data to content (e.g., a tutorial).

In some approaches, smartphone applications provide virtual makeup tryouts, which use augmented reality or extended reality (“AR” or “XR,” respectively) to simulate the application of makeup in a live digital image. For instance, a makeup product, such as lipstick or lip gloss, may be chosen for virtual application and the AR application creates an image of the user overlaying the makeup over the image of the subject as captured by the device's camera.

However, such AR/XR virtual try-on applications typically lack a connection to digital content such as tutorials. For instance, such approaches do not link, e.g., a captured face, a reference look, and digital content (e.g., a tutorial video). Additionally, partially due to the large number of online tutorial content available, it is often difficult to identify a tutorial content item that is suited to personal facial features.

Virtual try-ons generally lack instructions on how to apply real makeup altogether, showing only the result of virtual makeup application. Thus, users will not know if they have applied the makeup correctly since virtual try-on applications only show a high-level simulation of what the user would look like with the real makeup. Such approaches lack a mechanism for monitoring for and analyzing real-time feedback of the user, which can be used to dynamically modify existing guidance or instructions or otherwise dynamically create one or more portions of the guidance. Such approaches also lack a mechanism for deconstructing or breaking a task into sub-applications specific to a user, which when combined may enable the task or objective to be completed. Further, such approaches lack computer-implemented mechanisms for identifying a target image makeup look, and determining which makeup to use to achieve that look and how to apply the makeup to a user interested in creating the target image makeup look for themselves.

There is a need for techniques that select and/or generate identifiers of products or instructions or guidance, or both products and guidance or instructions, e.g., based at least in part on real-time feedback in relation to a user from one or more sensors, to help the user complete or learn a task. In the context of a makeup application, for instance, it would be beneficial to provide identifiers of makeup products and/or tutorial for a makeup look desired by a user that is suited to the facial features of the user with the goal of achieving the target makeup image look.

The present disclosure relates to systems and methods that provide identifiers of product(s) and/or a virtual tutorial to a device associated with a user. While techniques are described herein for providing a virtual tutorial to a device associated with a user in the context of applying makeup, it should be appreciated that the disclosed techniques may be used for any suitable application or purpose. For example, the techniques disclosed herein may be used for a variety of virtual and/or real experiences, such as remote training applications, medical applications (e.g., virtual surgery training), other consumer applications (e.g., assembling and/or altering clothes, shoes, sunglasses, hats, or any other accessories or other clothing), robotics applications, and/or for any other suitable purpose, or any suitable combination thereof.

The systems and methods disclosed herein may be configured to provide a virtual tutorial to a device associated with a user. In some embodiments, a system obtains a user image comprising a face of a user. For example, the system may obtain the user image of the face of the user via a device associated with the user (e.g., a smart mirror, a camera of a smartphone, any other suitable user device, or any combination thereof). In some implementations, the system obtains a target image comprising a reference look. A target image may comprise data describing a desired reference look or reference model to be copied, modified, applied, and/or used as a template. For example, the reference look may comprise an image of makeup applied to a celebrity, influencer, friend of the user, and/or any other person wearing makeup and/or accessories.

In some embodiments, the system determines, from the device associated with the user, a target area of the target image of the reference look. For example, the user may select the eyes of the reference look as the target area (e.g., the user wants to achieve the eye makeup look of the target image). Such aspects may be used to deconstruct or break up a task (e.g., instructions to help achieve or imitate a reference look) into sub-applications (e.g., instructions for the eye makeup of the reference look, instructions for lipstick of the reference look, etc.). In some embodiments, the system may identify a virtual tutorial for performing at least one action to the target area of the user, wherein the identifying the virtual tutorial is based at least in part on the user image, the target image, and the target area, and provide identifiers of a product(s) and/or the virtual tutorial to the device associated with the user.

In some implementations, to obtain the virtual tutorial, the system provides data indicative of the image, the target image, and the target area as input into a trained machine learning model. For example, the trained machine learning model may use a neural network such as a support vector machine (SVM), multilayer perceptron (MLP), convolutional neutral network (CNN), any other suitable machine learning algorithm, or any suitable combination thereof. In some implementations, the system identifies a virtual tutorial for performing at least one action to the target area of the user, wherein the identifying the virtual tutorial is based at least in part on the user image, the target image, and the target area. For example, based at least in part on the data provided as input into the trained machine learning model, the system receives as output, from the trained machine learning model, a virtual tutorial for performing at least one action to the target area of the user. For example, the virtual tutorial may provide product information and/or instructions to the user to apply eyeliner to a lash line of their eyes. In some embodiments, at least a portion of the virtual tutorial may comprise a generative artificial intelligence (AI) video. The virtual tutorial may comprise one or more of makeup product identification, video instruction, image instruction, textual instruction, or auditory instruction. In some embodiments, the virtual tutorial may be dynamically updated in real time, to provide focused, real-time feedback and guidance, based on detected actions by the user, and whether such actions deviate from guidance of the virtual tutorial. In some embodiments, the virtual tutorial may be dynamically updated in real time based on a current state of the user and whether the current state deviates from a predicted state at that time based on the instructions provided.

In some embodiments, the system obtains, based at least in part on the target image, at least one identifier (e.g., of a makeup product) and/or instruction from a database. For example, the database may comprise videos, images, text, product data, and/or other instruction data from a plurality of websites, applications, the internet, product database, any other suitable video database or other database, or any suitable combination thereof. For example, the system may query one or more websites, webpages, applications, databases, platforms, etc., accessible via the internet (and/or other network) for an eye makeup tutorial including product(s) used to achieve the eye makeup in the target image. In some embodiments, the term “tutorial” used herein includes any of one or more of a product suggestion or a makeup application instruction step, and it should be appreciated that the tutorial may be applied for any suitable process, training, or topic, in addition or in the alternative to cosmetic product(s). In some embodiments, the at least one instruction is a cosmetic tutorial video depicting cosmetics being applied to a face, which may be a face other than the face of the user. For example, an eye makeup tutorial that the system obtains from the internet is input into the trained machine learning model. In some embodiments, the database may be indexed based on, e.g., demographics, different regions of the face, keyword, and/or any other suitable data. The eye makeup tutorial may depict eye makeup being applied to the eyes of an influencer. In some implementations, the virtual tutorial depicts cosmetics being applied to the face of the user. For example, the system may use generative AI to depict the face of the user in place of the face of the influencer in the originally obtained eye makeup tutorial.

In some implementations, the system provides the virtual tutorial to the device associated with the user. For example, the system may generate for simultaneous display, on an interface of the device associated with the user, the image comprising the face of the user, the target image comprising the reference look, and the virtual tutorial. In some embodiments, the virtual tutorial comprises a zoomed-in view of the target area on the face of the user. In some embodiments, wherein the target area is a first target area and the virtual tutorial is a first virtual tutorial, the system receives a selection, from the device associated with the user, of a second target area of the target image of the reference look. For example, the system receives a selection of the lips of the face of the reference look in the target image. In some embodiments, the system identifies a second virtual tutorial for performing at least one action to the second target area of the user, wherein the identifying the second tutorial is based at least in part on the second target area. In some embodiments, the system provides the second virtual tutorial to the device associated with the user. Such aspects provide further sub-applications (e.g., instructions for different target areas) that, when performed in combination, result in the completion of a task (e.g., imitating a reference look comprised of target areas).

In some embodiments, wherein the virtual tutorial is a first virtual tutorial and the at least one action is a first action, the system determines at least one visual difference between the image comprising the face of the user and the target image comprising the reference look. For example, the system determines that the cheek makeup of the image of the user does not match the cheek makeup of the target image of the reference look. In some implementations, based at least in part on the at least one visual difference, the system provides a second virtual tutorial for performing a second action to a region of the face of the user comprising the at least one visual difference. For example, the system provides an identifier of a product based on the visual difference and a tutorial from YouTube® for blush and contour that looks like the cheek makeup of the target image.

In some embodiments, the system may receive data indicative of the plurality of cosmetic products available to the user from a user input from the device associated with the user. In some embodiments, the system may receive the data indicative of the plurality of cosmetic products available to the user from a camera of the device associated with the user. For example, the system may determine, via direct user input, that the user owns a Maybelline® black liquid eyeliner, a L'Oréal® mascara, a Charlotte Tilbury® lip liner, and a Dior® clear lip gloss. An available product list—captured, entered manually, or based on past purchases—for each user may be stored, e.g., in a profile, library, and/or database. In some implementations, the virtual tutorial for performing the at least one action to the target area of the user comprises one or more instructions that utilize one or more cosmetic products of the plurality of cosmetic products available to the user. For example, the virtual tutorial may include an instruction instructing the user to use their Maybelline® black liquid eyeliner on their lash line. In some embodiments, the target image may be used to determine the proper product(s) required or recommended to achieve the target makeup look. Such product(s) can be determined using image analysis, color and/or texture determination, comparison with product data, and/or any other appropriate techniques, to obtain then find the available product(s) from a makeup provider database using the data determined from the analysis.

In some embodiments, the system determines that the one or more steps of the virtual tutorial for performing the at least one action to the target area of the user requires at least one cosmetic product that is not included in the plurality of cosmetic products available to the user.

For example, the system may determine that the user does not own the correct type of eyeliner (e.g., pencil versus liquid). In another example, the system may determine that the user owns the incorrect shade or color of a product (e.g., pink gloss versus clear gloss). Based at least in part on the determining, in some implementations, the system provides a recommendation to the device associated with the user to purchase the at least one cosmetic product. For example, the system provides for display an advertisement to purchase a black eyeliner pencil. In another example, the system provides an updated target look based on what the user can achieve with the products they have.

In some embodiments, the system aligns facial features of the face of the user with facial features of the reference look in the target image. Based at least in part on the aligning, in some embodiments, the system generates for display at the device a visual overlay of guidelines indicating where to perform the at least one action on the face of the user. For example, the system may generate for display indications, such as dashed lines, at the region of the smart mirror depicting, e.g., a lash line of the user's eyes, to indicate to the user where to apply their eyeliner. In some implementations, the system determines that the user, applying cosmetics, is deviating from guidance in the virtual tutorial in relation to the target area. For example, the system may detect that the product is being applied outside the target area and/or that too much blush has been applied to the cheek. In some embodiments, the system updates the guidance of the virtual tutorial for at least one other area of the face of the user, based at least in part on the determining. For example, the system may update the tutorial to include a step to correct the current target area result by, for example, applying a foundation powder over the blush to neutralize the color of the blush. The summary is provided to facilitate an understanding of the concepts disclosed herein and should not be considered limiting of the breadth, scope, or applicability of these concepts.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts an illustrative example of providing computer-assisted guidance, e.g., a virtual tutorial or instructions, to aid a user in performing a task, in accordance with some embodiments of this disclosure.

FIG. 2 depicts an illustrative example of providing computer-assisted guidance, e.g., a virtual tutorial or instructions, to aid a user in performing a task, in accordance with some embodiments of this disclosure.

FIG. 3 depicts an illustrative example of providing recommendations for products, in accordance with some embodiments of this disclosure.

FIG. 4 depicts an illustrative example of providing computer-assisted guidance based on target areas, in accordance with some embodiments of this disclosure.

FIG. 5 depicts illustrative user equipment devices and systems, in accordance with some embodiments of this disclosure.

FIG. 6 depicts illustrative user equipment devices and systems, in accordance with some embodiments of this disclosure.

FIG. 7 depicts a flowchart of a detailed illustrative process for providing computer-assisted guidance, e.g., a virtual tutorial or instructions, to aid a user in performing a task, in accordance with some embodiments of this disclosure.

FIG. 8 depicts a flowchart of a detailed illustrative process for providing a makeup solution, in accordance with some embodiments of this disclosure.

### DETAILED DESCRIPTION

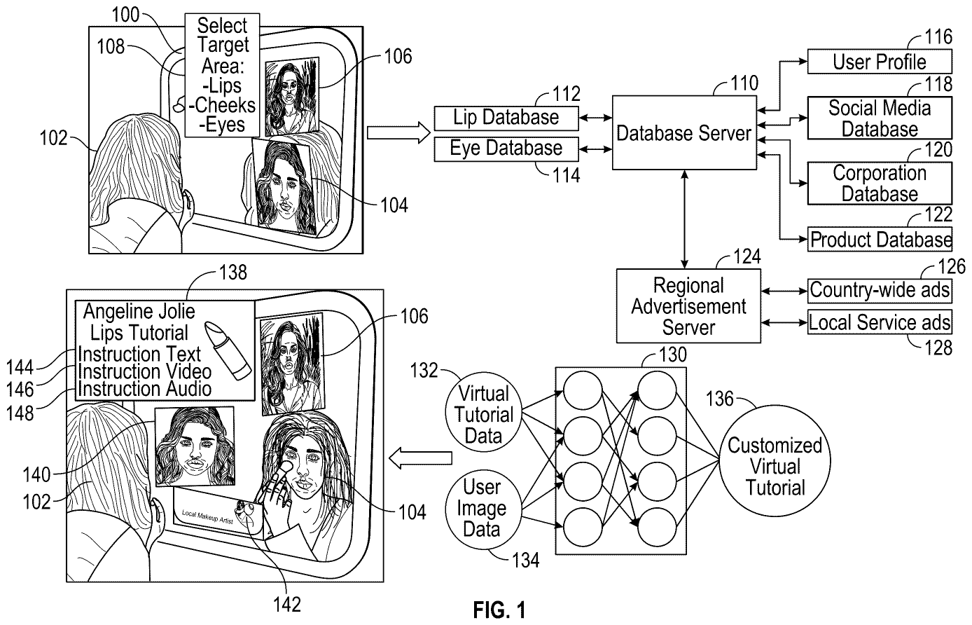

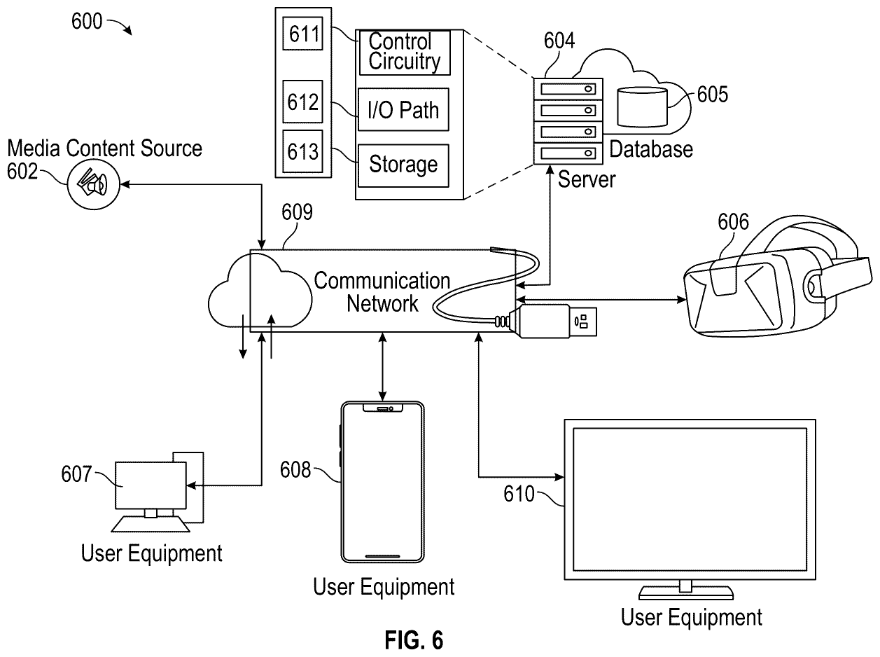

FIG. 1 depicts an illustrative example of providing computer-assisted guidance, e.g., a virtual tutorial or instructions, to aid a user in performing a task, in accordance with some embodiments of this disclosure. FIG. 1 illustrates a system configured to perform various functions described herein. In some embodiments, the system comprises or corresponds to an application that may be executed at least in part on a server (e.g., media content source 602 and/or one or more servers 604 of FIG. 6), a user equipment device such as device 100 (e.g., devices 606, 607, 608, and/or 610 of FIG. 6, such as, for example, a smartphone (e.g., with a front-facing camera), or tablet, a laptop computer, a personal computer, a desktop computer, a smart television, a smart watch or wearable device, smart glasses, a stereoscopic display, a wearable camera, XR glasses, XR goggles, an XR head-mounted device (HMD), a near-eye display device, etc.), a smart mirror, or any other suitable user equipment or computing device, or any combination thereof. The application and/or system may comprise or employ any suitable number of displays, sensors, or devices such as those described herein, or any other suitable software and/or hardware components, or any combination thereof.

In some embodiments, the system obtains a user image (e.g., user image 104) comprising a face of a user (e.g., user 102). The system may receive input from user 102 of device 100 requesting to access an application or platform associated with the system, such as a makeup application. The system may obtain user image 104 via a device (e.g., device 100) associated with user 102, such as a smart mirror, a camera of a smartphone, a laptop, any other suitable electronic device, or any combination thereof. In some embodiments, device 100 comprises at least one screen and a video camera configured to display multiple representations of a user makeup session. User image 104 may be dynamic and/or live and/or an instance of an image. In some embodiments, user image 104 is a live video. In some embodiments, user image 104 is a live reflection. Device 100 may be logged in to an application running the system. The application may comprise a user account and/or user profile associated with user 102.

In some implementations, the system obtains a target image (e.g., target image 106) comprising a reference look. For example, the reference look may be a visual appearance of a makeup look on a celebrity, influencer, friend of the user, person from an advertisement, magazine, entertainment content or other media asset (e.g., wearing makeup for a Halloween costume, wearing makeup for a sports game, or wearing makeup with a wedding dress), any other suitable person, or any combination thereof. Device 100 may receive target image 106 from various sources. User 102 may have captured an image of someone wearing makeup and that target image 106 may be stored on a second device (e.g., a smartphone). User 102 may share that image, via the second device, with device 100 over a network link (e.g., Bluetooth or Wi-Fi). In some implementations, device 100 receives target image 106 from a cloud service where user 102 uploads an image. In some embodiments, device 100 may offer a library of “looks” that user 102 can select from directly on device 100. In some embodiments, the system may access digital photo album(s) (e.g., of the user) to select target image 106. The system may obtain target image 106 based on a user input received from user 102 of device 100. As another example, the system may obtain target image 106 from a user input from a second device associated with user 102 (e.g., via a smartphone or tablet running the application using the system). The system may prompt user 102 to input, upload, and/or select a target image. In some embodiments, the system obtains target image 106 from a database of target images (e.g., accessible via the internet).

The reference look may additionally or alternatively comprise any suitable visual appearance, e.g., jewelry or clothing items such as shirts, skirts, blouses, dresses, pants, any other suitable clothing item, or any suitable combination thereof. The system may analyze the clothing items in the reference look and identify the particular items from a database (e.g., database server 110). The system may determine alternative items to the particular items that vary in price. The system may provide identifiers of the particular items and/or identifiers of the alternative items to help user 102 recreate the reference look.

In some embodiments, the system determines, from a device associated with the user (e.g., device 100), a target area of target image 106 of the reference look. For example, the target area may be a part of the face, such as any one or more of the eyes, lips, cheeks, bone structure of overall face or portion of the face, any other target look, such as an overall outfit or part thereof, any other suitable area of the face, any other suitable area of a user, or any suitable combination thereof. In some implementations, the system receives a selection of the target area from a user input. For example, the system receives a selection (e.g., touchscreen input, voice input, mouse input, stylus input, or any other suitable input) of a user interface option “Lips” from user 102 at target area menu 108. In some embodiments, the system determines the target area by determining at least one visual difference between user image 104 and target image 106 comprising the reference look. For example, in a case where the user is depicted as wearing makeup in user image 104, the system determines that the lip makeup of user image 104 does not match the lip makeup of target image 106 of the reference look. In some implementations, the system determines that the at least one visual difference by determining that at least one region of user image 104 exceeds a visual-difference threshold with respect to at least one region of target image 106.

In some embodiments, the system may select more than one target area based on the analysis of the difference between the current user's face (e.g., user image 104) and the desired outcome image (e.g., target image 106), and/or based on received user input. In some embodiments, the system receives a selection of the target area from a second device associated with user 102 (e.g., via a smartphone or tablet running the application using the system). In some embodiments, no target area may be specified for user 102 or requested by the system, and in such a circumstance the system may assume that user 102 desires to have their whole face resemble the face in target image 106 in its entirety. In some embodiments, user 102 may specify portions of the target image they do not wish to emulate, e.g., voice input may be received of “I want to look like this image of Angelina Jolie except for her eyebrows.”

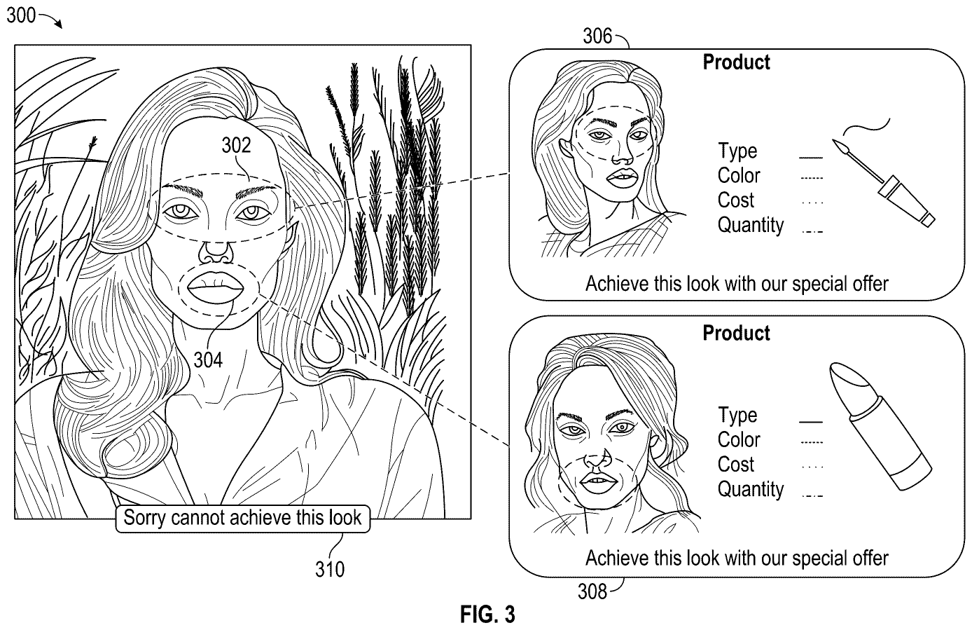

In some embodiments, the system identifies a virtual tutorial (e.g., virtual tutorial 138) for performing at least one action to the target area of user 102, based at least in part on user image 104, target image 106, and/or the target area. Virtual tutorial 138 may comprise instructions that, when followed by a user (e.g., user 102 applying makeup to their own face or other body part based on the instructions in the virtual tutorial), guide or cause the user to achieve the look of the target area of target image 106. For example, user 102 may follow virtual tutorial 138 (e.g., “Angelina Jolie lips tutorial”) to make her lips appear more like the lips in target image 106 (depicting Angelina Jolie). In some implementations, the virtual tutorial comprises makeup product identification, video instruction, image instruction, textual instruction, auditory instruction, any other suitable instruction, or any suitable combination thereof. In some embodiments, virtual tutorial 138 comprises one or more identifiers of cosmetic products and/or one or more instructions that utilize one or more cosmetic products of a plurality of cosmetic products available to user 102, as described in more detail in connection with FIG. 3. In some embodiments, the one or more instructions of virtual tutorial 138 comprise at least one illustration and/or example of cosmetics being applied to a face of a user other than the face of user 102.

For example, the system may obtain, based at least in part on target image 106, at least one instruction or product from a database (e.g., database server 110). The system may obtain at least a portion of virtual tutorial 138 (e.g., instruction text 144, instruction video 146, instruction audio 148) from database server 110 and/or any of the databases in communication with database server 110 (e.g., user profile 116, social media database 118, corporation database 120 (which may include videos or other content including product information, such as cosmetics product information published by a cosmetics company or cosmetics organization), product database 122, regional advertisement server 124, country-wide ads 126, local service ads 128, lip database 112, eye database 114, any other suitable database, or any suitable combination thereof). For example, the system may obtain at least a portion of virtual tutorial 138 from social media database 118 (e.g., a content application that stores and provides access to user-generated content, such as YouTube).

In some embodiments, user 102 inputs the data of at least one product they already own into a product input database (not shown). For example, user 102 inputs one or more identifiers of makeup products, such as cosmetic products (e.g., foundation, contour, lip, eye, eyebrow cosmetic products, etc.) or other products (e.g., clothing products, hair products, etc.). Each product input or output category and associated information may be stored in a single database or separated into more specified database(s) e.g., lip database 112, eye database 114. In some embodiments, the location of the database(s) are local to the user application or stored remotely with a user profile controlled by the user or controlled by an entity outside the user's control, such as a product or instruction provider e.g., Macy's type entity, Sephora type entity, YouTube type entity, Instagram type entity, etc. In some embodiments, the system may provide user 102 with a questionnaire that provides more detail of the desired target look and initial start look. For example, the system may receive a questionnaire filled out by user 102 that indicates target look information that cannot be determined by an input image alone, such as origin, desired skin type, hair texture, clothes product material, any other target look information, or any appropriate combination thereof.

In some embodiments, database server 110 may be indexed based on, e.g., demographics, different regions of the face, keyword, product data, and/or any other suitable data. For example, the system may query database server 110 for “Angelina lips,” “Jolie lips,” “Angelina Jolie,” “lips,” and/or “Angelina Jolie lips,” to identify instructions or tutorials related to the facial appearance or other appearance in target image 106. In some embodiments, user 102 and/or other users may upload videos, audio, images, and other instructions to the database. In some embodiments, the system analyzes a plurality of virtual tutorials from database server 110 to identify products, videos, or portions likely to help user 102 achieve the reference look of target image 106. The system may deconstruct the plurality of virtual tutorials into sub-applications and combine the sub-applications to provide virtual tutorial 138. The system may also use the sub-applications to provide dynamic, real-time guidance and feedback.

Upon receiving selection of target image 106, the system may proceed to analyze target image 106 to generate or determine makeup instructions. The system may first align facial features of user image 104 with target image 106. Machine learning models such as OpenPose may be used to detect facial features on both images and then scale and align them. A facial analysis module may perform facial analysis on the video-camera capture in real time to extract facial features such as relative eyes, mouth, and nose locations, space between eyes, skin color, skin conditions such as redness or blemishes, eyebrow thickness, or eyelashes position, color or length. The output of the facial analysis module may be a virtual representation of user facial feature(s) and represent a current state of user 102. This representation may not be visible to user 102 but may be used by device 100 internally as user 102 moves around to align with target image 106.

In some embodiments, a machine learning model trained on extracting makeup product or process information may be used on both the aligned target image 106 and user image 104.

Based on the detected makeup information in target image 106, device 100 may then present user 102 with selectable makeup areas that correspond to areas on user 102 that need a makeup application to achieve the desired outcome (e.g., target area menu 108). For example, the system may identify the eyes and lips areas as makeup focus areas where makeup application may be performed to match target image 106. A machine learning model may then transfer the extracted makeup information from the desired outcome image in the selected focus area to user image 102 and generate a personalized desired outcome image (e.g., customized goal image 140). In some embodiments, one or more machine learning models are utilized to perform the described processes, e.g., extracting makeup information, generating a personalized desired outcome image, etc.

In some embodiments, the system provides as input to a trained machine learning model (e.g., machine learning model 130) data indicative of the at least one instruction, product, and/or other data. For example, the trained machine learning model may use a neural network such as an SVM, MLP, CNN, any other suitable machine learning algorithm, or any suitable combination thereof. In some embodiments, the system additionally or alternatively provides as input to machine learning model 130 data indicative of user image 104, target image 106, and/or the target area(s). For example, the system provides as input to machine learning model 130 data of the virtual tutorial identified from database server 110 (e.g., virtual tutorial data 132) and data of user image 104 (e.g., user image data 134). In some implementations, the system receives as output from machine learning model 130 customized virtual tutorial 136. Customized virtual tutorial 136 may comprise data from the virtual tutorial identified from database server 110 that is modified to include facial features from user image 104, e.g., to give the appearance that user 102 themself is in the virtual tutorial that user 102 may follow along with and imitate. For example, the system provides, in addition to virtual tutorial 138, customized goal image 140, which comprises user image 104 augmented with the target area of target image 106. In some embodiments, customized virtual tutorial 136 corresponds to virtual tutorial 138.

In some embodiments, machine learning model 130 may be trained by an iterative process of adjusting weights (and/or other parameters) for one or more layers of machine learning model 130. For example, the system may compare the outputs obtained when training data is input to machine learning model 130 to a ground truth value (e.g., an annotated indication of the correct output or a threshold of similarity to the target image 106). The threshold may be set by the user or the machine learning model 130. The video capture application may then adjust weights or other parameters of machine learning model 130 based on how closely the output corresponds to the ground truth value. The training process may be repeated until results stop improving or until a certain performance level is achieved (e.g., until 95% accuracy is achieved, or any other suitable accuracy level or other metrics are achieved). In some embodiments, machine learning model 130 may be trained to learn features and patterns with respect to particular features of input data, and such learned patterns and inferences may be applied to received data once machine learning model 130 is trained. In some embodiments, machine learning model 130 may continue to dynamically adapt in real time using feedback (also referred to in the art as “on the fly.” Machine learning model 130 may actively and/or passively adapt. In some implementations, machine learning model 130 may be adjusted on the fly for continuous improvement, based on input data and inferences or patterns drawn from the input data, and/or based on comparisons after a particular number of cycles. In some embodiments, machine learning model 130 may comprise any suitable number of parameters.

In some embodiments, machine learning model 130 may be trained with any suitable amount of training data from any suitable number and/or types of sources. In some embodiments, machine learning model 130 may be trained by way of unsupervised learning, e.g., to recognize and learn patterns based on unlabeled data. In some embodiments, machine learning model 130 may be trained by supervised training with labeled training examples to help the model converge to an acceptable error range, e.g., to refine parameters, such as weights and/or bias values and/or other internal model logic, to minimize a loss function.

In some embodiments, each layer may comprise one or more nodes that may be associated with learned parameters (e.g., weights and/or biases), and/or connections between nodes may represent parameters learned during training (e.g., using backpropagation techniques, and/or any other suitable technique). In some embodiments, the nature of the connections may enable or inhibit certain nodes of the network. In some embodiments, the system may be configured to receive (e.g., prior to training) user specification of (or automatic selection of) hyperparameters (e.g., a number of layers and/or nodes or neurons in each model). The system may automatically set or receive manual selection of a learning rate, e.g., indicating how quickly parameters should be adjusted. In some embodiments, the training image data may be suitably formatted and/or labeled by human annotators or otherwise labeled via a computer-implemented process. As an example, such labels may be categorized as metadata attributes stored in conjunction with or appended to the training image data. Any suitable network training patch size and batch size may be employed for training machine learning model 130. In some embodiments, machine learning model 130 may be trained at least in part using a feedback loop, to help learn user preferences over time (e.g., reinforcement learning). In some embodiments, the system may perform any suitable pre-processing steps with respect to training data, and/or data to be input to the trained machine learning model. Machine learning model 130 and the training data may be stored at (and/or implemented at) any suitable device(s) and/or server(s) associated with the system.

In some implementations, the at least one instruction of virtual tutorial 138 is a cosmetic tutorial video depicting cosmetics being applied to a face other than the face of user 102, and virtual tutorial 138 depicts the cosmetics being applied to the face of the user. For example, customized goal image 140 depicts what user 100 may look like after following the instructions of virtual tutorial 138. In some embodiments, the at least one instruction is a cosmetic tutorial video depicting cosmetics being applied to the face of user 102. For example, user 102 may have previously had their makeup professionally done by a makeup artist and now wants to recreate the look themself, e.g., user 102 may submit an image of themself, such as user image 104, of when such makeup was professionally or otherwise previously done.

In some implementations, the system provides virtual tutorial 138 to device 100 associated with user 102. For example, the system generates for simultaneous display, on an interface of device 100 associated with user 102, user image 104 comprising the face of user 102, the target image 106 comprising the reference look, virtual tutorial 138, customized goal image 140, and/or advertisement 142, and/or any other suitable content. The system may provide for display advertisement 142 comprising an advertisement for a business (e.g., a local makeup artist) that can help user 102 achieve the desired outcome in the selected targeted area. In some embodiments, virtual tutorial 138, or another content item displayed at device 100, comprises a zoomed-in view of the target area on the face of user 102. In some embodiments, virtual tutorial 138 comprises a zoomed-in view of the target area of target image 106 of the reference look. The system may regenerate a zoomed-in view of the target area on the face of user 102 and/or of target image 106 in real time as user 102 applies makeup based on user image 104. In some embodiments, at least a portion of the virtual tutorial comprises a generative artificial intelligence (AI) video. The system may input data indicative of user image 104, target image 106, and/or the target area into machine learning model 130, any other suitable generative AI model, or any suitable combination thereof. The system may receive a generative AI video from machine learning model 130. The system may use generative AI to replace the image of the face in virtual tutorial 138 with the face of user 102.

In some embodiments, the target area is a first target area, virtual tutorial 138 is a first virtual tutorial, and the system receives a selection, from device 100 associated with user 102, of a second target area of target image 106 of the reference look. For example, the system may receive a selection of “cheeks” from target area menu 108. In some implementations, the system identifies a second virtual tutorial for performing at least one action to the second target area of user 102. In some embodiments, the system identifies the second virtual tutorial based at least in part on the second target area. For example, the system may identify a cheek contouring tutorial video from corporation database 120 (e.g., the brand of the product used in target image 106 may have virtual tutorials for their products). In some embodiments, the system provides the second virtual tutorial to device 100 associated with user 102. In some embodiments, the second virtual tutorial is a dynamic, real-time modification of the first virtual tutorial (e.g., virtual tutorial 138). In some embodiments, instructions for multiple target areas for achieving a target look may be provided in the same virtual tutorial, e.g., based on user input selecting multiple target areas. In some embodiments, the system may receive requests for multiple target looks, along with user instructions, e.g., I want Angelina Jolie's lips from target image 106, and I want another person's eyes from another target image.

In some implementations, the system may use any suitable computer-implemented technique to align facial features of the face of user 102 with facial features of a user shown in the reference look in target image 106. For example, the system may generate for display target image 106 as a transparent overlay over user image 102. In another example, the system aligns the facial features of user 102 with the facial features of target image 106 without generating for display an overlay. In some embodiments, based at least in part on the aligning, the system generates for display at device 100 a visual overlay of guidelines indicating where to perform the at least one action on the face of user 102. For example, the system may generate for display, at an interface of device 100, lines over the regions of the interface of device 100 displaying user image 104. The system may instruct user 102 to apply cosmetics either on the areas of the face corresponding to the displayed lines and/or within the displayed lines. In some embodiments, the guidelines, application region, and/or instructions may be presented to user 102 via a “coloring book”-fashion visual instruction comprising an outlined section on device 100. In some embodiments, the guidelines may comprise additional audio and/or text.

In some implementations, the system dynamically updates the virtual tutorial 138 based on real-time feedback of the user, e.g., capturing images of the user while the user is applying makeup and analyzing the images, including comparing a visual appearance of the face of the user in to facial features of the person depicted at a corresponding point in the makeup process in virtual tutorial 138. For example, the system determines that user 102, applying cosmetics, is deviating from guidance in virtual tutorial 138 in relation to the target area and/or otherwise deviating from the target area of target image 106. For example, the system may determine that user 102 is applying product (e.g., contour) outside of a threshold range of displayed guidelines. In some embodiments, the system updates the guidance of virtual tutorial 138 for at least one other area of the face of user 102, based at least in part on the determining. For example, if the system determines that user 102 has applied too much contour to their cheeks, the system may provide additional instructions to apply foundation powder over particular regions of the cheeks to compensate for the contour application. The system may optimize, via machine learning model 130, the updating of the guidance of virtual tutorial 138 so that virtual tutorial 138 has a minimum number of changes required in other selected application areas but still satisfies user 102 with the overall look. For example, the system may detect that the user has applied a dark red lipstick in a first target area instead of a purple lipstick. Based on this detection, the system may transfer that difference in color tone to the eye area (the second application area). The system may comprise a database or a machine learning model (e.g., machine learning model 130) that contains or generates layered representations of a target area.

In some embodiments, the system has access to a makeup stock of user 102. The system may store data indicating the makeup stock of user 102 in a database (e.g., database server 110), on device 100, on a remote server, any other suitable storage, or any suitable combination thereof. In some embodiments, the system receives data of at least one makeup product available to user 102 (e.g., a stock keeping unit or SKU) and receives information on the product such as type, color, type of applicator, brand, etc. In some implementations, the system may identify product composition information. For example, the system may determine certain compounds in a product and not recommend the product to the user (e.g., if the system receives an indication that the user is allergic to the particular compound or the system receives an indication that the user does not want to use products with compounds sourced from animals). The system may prompt user 102 to scan a barcode of a makeup product to derive the SKU and/or other information about the product. In some embodiments, the system may already have the barcode information and/or other identifying information of the product (e.g., based on a user's past purchase history, previous searches, etc.), and may present a recommendation of such product (e.g., for immediate use, or may push the recommendation to, for example, a secondary device of the user for a later use). In some implementations, the system retrieves the product information using an application programming interface (API) of a brand. In some embodiments, an application or a device running the system is provided by a brand (such as Revlon or L'Oréal) or a store such as Amazon or Sephora. In these embodiments, the system may use a custom API to gather information about makeup products.

In some embodiments, the system determines the plurality of cosmetic products available to user 102 by analyzing a purchase history of user 102. In some implementations, the system uses computer vision techniques to identify what user 102 is holding or other objects in a field of view of a camera of device 100. In some embodiments, the system associates makeup products in the makeup stock of user 102 with an area of particular makeup application (e.g., target areas). For example, the system may associate a lipliner product with the lip border, a lipstick with the middle of the lips, and a lip gloss with the center of the lips. In some implementations, the system provides at least one instruction to use a product from the makeup stock of user 102 for at least one part of virtual tutorial 138. For example, the system may provide an instruction “Use your Maybelline lip liner in the shade ‘Rich Wine’ around your lip line.” In some embodiments, the system provides instruction to use a particular product available to user 102 when the system identifies the particular product in target image 106. In some embodiments, the system provides instruction to use a particular product available to user 102 when the system identifies a similar product in target image 106.

In some implementations, the system may provide indications of makeup products to achieve the desired look of target image 106 based on makeup databases (e.g., database server 110) and/or AI that has stored instances of successful achievements of such a target look, e.g., based on previously generated and provided virtual tutorials. In another example, the system learns over time what makeup techniques, guidelines, and/or instructions best suit user 102 and customizes the virtual tutorials over time. In some embodiments, the system determines which products are compatible with different skin types and other products. The system may then recommend products that are compatible with the skin type of user 102 and with the products available to user 102. For example, if the system receives a target image 106 from device 100 associated with user 102, and target image 106 depicts a person with a different facial bone structure (e.g., a visual difference between user 102 and the subject of the target image) than user 102 naturally has (e.g., user image 104), the system may learn which guidance makeup areas will achieve the desired target makeup look, e.g., to make the facial bone structure more closely resemble the facial bone structure of the person depicted in target image 106. For example, the system may identify sections around the cheeks and jawline and indicate to user 102 instructions of where to place selected makeup shading products. These instructions may be stored in one or more databases (e.g., database server 110) or may be the result of an analysis that associates a delta in makeup association with a set of layered instructions to apply a particular type of makeup.

In some embodiments, the system provides to device 100 a recommendation of which makeup product to use. In some implementations, the system provides the recommendation to a second device (e.g., a smartphone) associated with user 102. In some implementations, the system also considers the stock of makeup application tools of user 102, such as brushes and pencils, to assess the feasibility of achieving the desired outcome. For example, if the desired outcome includes very thin lines of eyeshadows but the makeup application tools stock of user 102 has only large brushes or pencils, the system may identify the desired outcome as unlikely to be achieved given the current resources of user 102, as described further below in connection with FIG. 3.

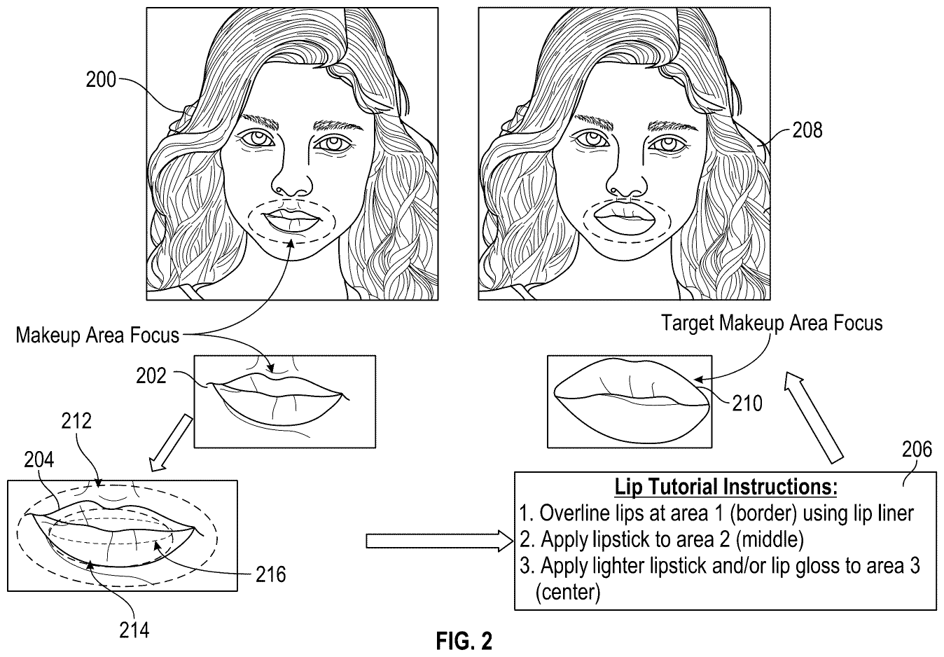

FIG. 2 shows an illustrative example of computer-assisted guidance, e.g., a virtual tutorial or instructions, to aid a user in performing a task, in accordance with some embodiments of this disclosure. FIG. 2 illustrates a system configured to perform various functions described herein. In some implementations, the system described in connection with FIG. 2 is the same system described in connection with FIG. 1. In some embodiments, the system comprises or corresponds to an application that may be executed at least in part on a server (e.g., media content source 602 and/or one or more servers 604 of FIG. 6), a user equipment device (e.g., devices 606, 607, 608, and/or 610 of FIG. 6, such as, for example, a laptop computer, a personal computer, a desktop computer, a smart television, a smart watch or wearable device, smart glasses, a stereoscopic display, a wearable camera, XR glasses, XR goggles, an XR HMD, a near-eye display device, etc.), a smart mirror, or any other suitable user equipment or computing device, or any combination thereof. The application and/or system may comprise or employ any suitable number of displays, sensors, or devices such as those described herein, or any other suitable software and/or hardware components, or any combination thereof.

In some embodiments, the system obtains a user image (e.g., user image 200) comprising a face of a user. The system may obtain user image 200 via a device (e.g., device 100 of FIG. 1) associated with the user such as a smart mirror, a camera of a smartphone, any other suitable electronic device, or any combination thereof. User image 200 may be dynamic, live, and/or an instance of an image. In some embodiments, user image 200 is a live video. In some embodiments, user image 200 is a live reflection. In some implementations, the system obtains a target image (e.g., target image 106 of FIG. 1) comprising a reference look. The target image may comprise an entire face and/or particular target regions (e.g., lips, eyes, etc.) (e.g., target makeup area focus 210).

In some embodiments, the system receives a selection of a target area (e.g., makeup area focus 202) from a device (e.g., device 100 of FIG. 1) associated with a user (e.g., the user associated with user image 200). For example, user 200 selects “lips” from, e.g., target area menu 108 of FIG. 1 via device 100 of FIG. 1. In some embodiments, the system identifies instructions associated with target makeup area focus 210. As shown in 204, the system may identify subregions of makeup area focus 202. For example, at 204, the system identifies three distinct regions of makeup area focus 202: a border region 212 representing the area around the lips themselves, a middle region 214 representing the visible part of the lips, and a central region 216 representing the area of the lips that is at the center of the visible part of the lips when the user has their mouth closed. For example, border region 212 may be an area around the natural lip border. Makeup may be applied to border region 212 to make the lips look larger. The specific makeup application area indications (e.g., dashed lines, solid lines, colored lines, etc.) may visually indicate at a user interface of device 100 where the makeup product is to be applied. Such aspects may prevent error by using the facial data of user 200 and target image data to indicate the best area for makeup application to achieve the desired target look. The system may identify subregions in other target areas (e.g., around an eye such as the eyelid, the crease, the inner corner, the outer corner, the lash line, the waterline, and the eyebrows).

Each of these regions may be further associated with a makeup solution (e.g., lip tutorial instructions 206) and/or an identifier (e.g., of a makeup product) to go from an initial state in which no makeup is applied (e.g., user image 200) to a final state representing the desired makeup outcome localized in the area of particular makeup application (e.g., customized goal image 208). For example, to achieve the example target look of larger lips, the system may provide the following instructions: 1. Overline lips at area 1 (border region 212) using lip liner. 2. Apply lipstick to area 2 (middle region 214). 3. Apply lighter lipstick and/or lip gloss to area 3 (central region 216). Lip tutorial instructions 206 may comprise techniques to make the user's lips appear larger to achieve the example target look by applying lipliner “around the outside” of the lip line rather than “on” the lip line. The system may provide lip tutorial instructions 206 as text, image(s), video, audio, any other suitable instruction means, or any suitable combination thereof.

In some embodiments, the system may overlay lip tutorial instructions 206 on top of the current view of the user (e.g., user image 200) or in close proximity. In some embodiments, the system displays only target makeup area focus 210 (e.g., displays a zoomed-in view of target image). For example, if lip tutorial instructions 206 are part of an instruction video that presents the full face of a user, the system may display only the region of particular makeup application associated with the desired outcome (e.g., target makeup area focus 210).

FIG. 3 shows an illustrative example of providing recommendations for products, in accordance with some embodiments of this disclosure. FIG. 3 illustrates a system configured to perform various functions described herein. In some implementations, the system described in FIG. 3 is the same as the system described in FIG. 1. In some embodiments, the system comprises or corresponds to an application that may be executed at least in part on a server (e.g., media content source 602 and/or one or more servers 604 of FIG. 6), a user equipment device (e.g., devices 606, 607, 608, and/or 610 of FIG. 6, such as, for example, a laptop computer, a personal computer, a desktop computer, a smart television, a smart watch or wearable device, smart glasses, a stereoscopic display, a wearable camera, XR glasses, XR goggles, an XR HMD, a near-eye display device, etc.), a smart mirror, or any other suitable user equipment or computing device, or any combination thereof. The application and/or system may comprise or employ any suitable number of displays, sensors, or devices such as those described herein, or any other suitable software and/or hardware components, or any combination thereof.

In some embodiments, the system (as described in connection with FIG. 1) receives a target image (e.g., target image 300) of a reference look from a device associated with a user (e.g., device 100 of user 102 of FIG. 1). The system may identify a virtual tutorial to guide the user in achieving the reference look of target image 300. The system may also have access to data of products available to the user (e.g., a plurality of cosmetic products), as described in FIG. 1. In some embodiments, the system may detect the absence of a product in the user's stock that is necessary or recommended to achieve a particular desired makeup outcome of target image 300 (e.g., desired target area 302 and/or desired target area 304). For example, target image 300 includes larger lips, but the user's stock does not contain a dark red lip liner nor lipstick that can be used to overline the lips to provide a shaded look by way of the proper color for shading. In some embodiments, at 310, the system notifies the user that target image 300 is not achievable given the user's current makeup supply.

In some implementations, based at least in part on determining that the product is not in the plurality of cosmetic products, the system provides a recommendation (e.g., recommendation 306 and/or recommendation 308) associated with the user to purchase the at least one cosmetic product to achieve the reference look in target image 300. For example, the system may contact an advertisement server (e.g., regional advertisement server 124 of FIG. 1) to display an advertisement for a product allowing the user to achieve the desired makeup outcome. In some implementations, the system may provide a recommendation of a new applicator tool to purchase to achieve the reference look of target image 300. In some embodiments, the system may identify products from a database (e.g., database server 110 described in FIG. 1) to achieve the reference look of target image 300 and/or provide recommendations of the identified products for purchase to present to the user with the makeup instructions.

In some embodiments, the system may alter target image 300 to show the user, e.g., via an overlay or image, what outcome may be reached with the current user's makeup product stock and/or makeup application tool stock, without using the identified products for purchase. For example, the system may alter target image 300 to show a smaller lip shape that is achievable with the products available to the user. In some embodiments, the system may alter target image 300 to show the user, e.g., via an overlay or image, what outcome may be reached with the identified products for purchase. In some implementations, the system may also compute a plurality of alternate desired makeup outcomes not achievable with the current user's makeup stock and request advertisement for products allowing the user to achieve these alternate makeup outcomes. Such aspects may help the user determine whether to purchase and/or acquire the proposed products or proceed with what they already have. The system may use the user's shopping history, the user's profile, and/or the user's makeup stock to select which desired outcome looks and associated makeup product to present to the user. The system may order items associated with the desired outcome looks, or the alternate outcome looks that the user confirms.

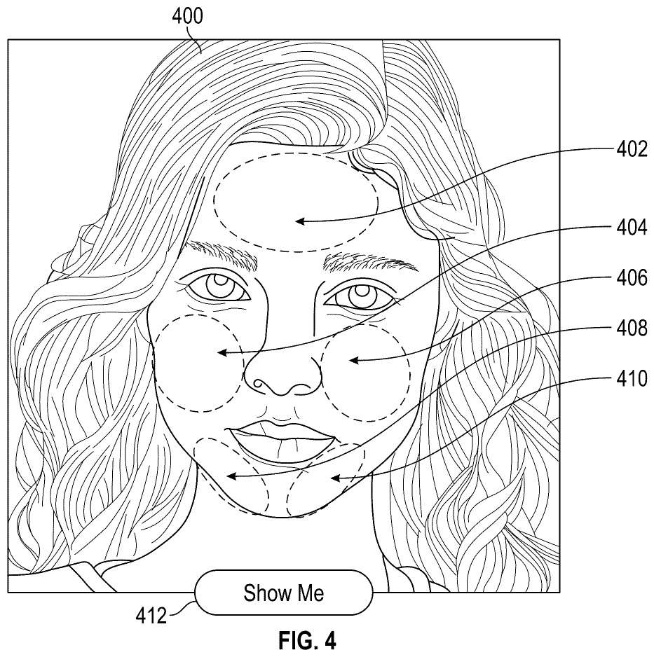

FIG. 4 shows an illustrative example of providing computer-assisted guidance based on target areas, in accordance with some embodiments of this disclosure. FIG. 4 illustrates a system configured to perform various functions described herein. In some implementations, the system described in FIG. 4 is the same as the system described in FIG. 1. In some embodiments, the system comprises or corresponds to an application that may be executed at least in part on a server (e.g., media content source 602 and/or one or more servers 604 of FIG. 6), a user equipment device (e.g., devices 606, 607, 608, and/or 610 of FIG. 6, such as, for example, a laptop computer, a personal computer, a desktop computer, a smart television, a smart watch or wearable device, smart glasses, a stereoscopic display, a wearable camera, XR glasses, XR goggles, an XR HMD, a near-eye display device, etc.), a smart mirror, or any other suitable user equipment or computing device, or any combination thereof. The application and/or system may comprise or employ any suitable number of displays, sensors, or devices such as those described herein, or any other suitable software and/or hardware components, or any combination thereof.

In some embodiments, the system (as described in connection with FIG. 1) receives a target image (e.g., target image 106 of FIG. 1) of a reference look from a device associated with a user (e.g., device 100 of user 102 of FIG. 1). The system may identify a virtual tutorial to guide the user in achieving the reference look of the target image. In some embodiments, the system computes a plurality of target areas (e.g., shading zone 402, shading zone 404, shading zone 406, shading zone 408, shading zone 410) using techniques described in FIG. 1. The system may compare user image 400 to the target image and determine to provide virtual tutorials for more than one target area. In some implementations, the system may receive a selection of which target area the user wants to address (e.g., from target area menu 108 of FIG. 1). In some embodiments, the system may receive a selection of more than one target area (e.g., “entire facial bone structure look”). For example, the system may provide the option for the entire facial bone structure look as a skeletal icon representing the entire facial bone structure look. In some embodiments, the system receives a selection of a more narrowly defined bone structure look (e.g., nose shading only) of the target image. Based on the selection(s), the system may show which shading zones (e.g., shading zone 402, shading zone 404, shading zone 406, shading zone 408, shading zone 410, any other suitable shading zone, or any suitable combination thereof) need to be shaded and precisely where to shade with a shading makeup. For example, upon receiving a selection of a target area and a user selection of “show me” option 412, the system may present instructions associated with a product associated with the target area and the desired makeup outcome.

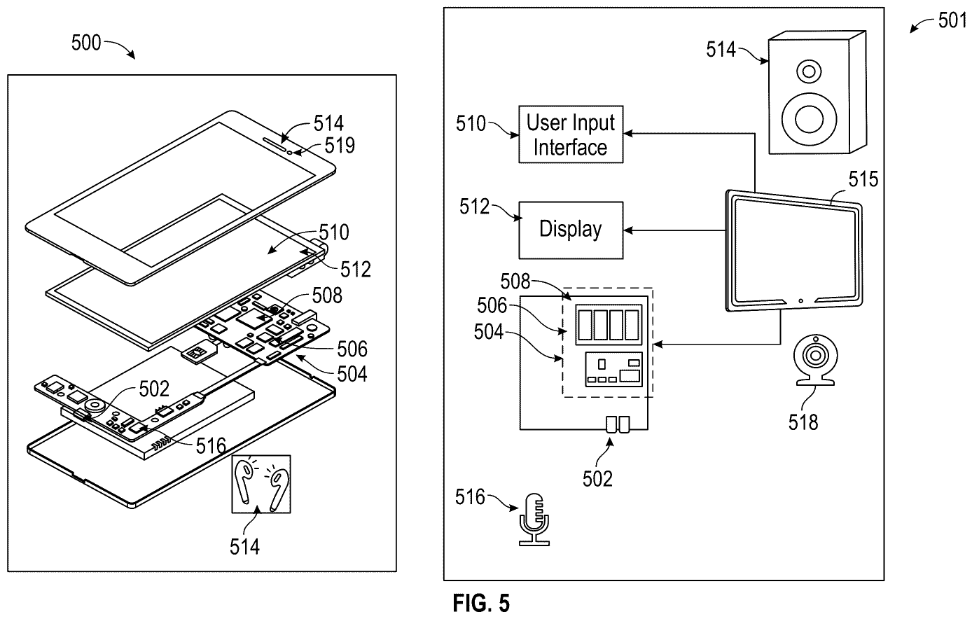

FIGS. 5-6 describe illustrative devices, systems, servers, and related hardware for applying an XR visual effect to a user and providing feedback to a user during a virtual tutorial associated with providing an XR visual effect, in accordance with some embodiments of the present disclosure. FIG. 5 shows generalized embodiments of illustrative user equipment 500 and 501, which may correspond to, e.g., user device 102 of FIG. 1. For example, user equipment 500 may be a smartphone device, a tablet, a near-eye display device, an XR device, or any other suitable device capable of participating in a XR environment, e.g., locally or over a communication network. In another example, user equipment 501 may be a user television equipment system or device. User equipment 501 may include smart mirror 515. Smart mirror 515 may be communicatively connected to microphone 516, audio output equipment 514 (e.g., speaker or headphones), and display 512. In some embodiments, microphone 516 may receive audio corresponding to a voice of a user and/or ambient audio data. In some embodiments, display 512 may be a television display or a computer display. In some embodiments, smart mirror 515 may be communicatively connected to user input interface 510. In some embodiments, user input interface 510 may be a remote-control device. Smart mirror 515 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 6. In some embodiments, user equipment 500 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 500. In some embodiments, user equipment 500 comprises a rechargeable battery that is configured to provide power to the components of the device.

Each one of user equipment 500 and user equipment 501 may receive content and data via input/output (I/O) path 502. I/O path 502 may provide content (e.g., broadcast programming, on-demand programming, internet content, content available over a local area network (LAN) or wide area network (WAN), and/or other content) and data to control circuitry 504, which may comprise processing circuitry 506 and storage 508. Control circuitry 504 may be used to send and receive commands, requests, and other suitable data using I/O path 502, which may comprise I/O circuitry. I/O path 502 may connect control circuitry 504 to one or more communications paths (described below). I/O functions may be provided by one or more of these communications paths but are shown as a single path in FIG. 6 to avoid overcomplicating the drawing. While smart mirror 515 is shown in FIG. 5 for illustration, any suitable computing device having processing circuitry, control circuitry, and storage may be used in accordance with the present disclosure. For example, smart mirror 515 may be replaced by, or complemented by, a personal computer (e.g., a notebook, a laptop, a desktop), a smartphone (e.g., user equipment 500), an XR device, a tablet, a network-based server hosting a user-accessible client device, a non-user-owned device, any other suitable device, or any combination thereof.

Control circuitry 504 may be based on any suitable control circuitry such as processing circuitry 506. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 504 executes instructions for the system (as described in connection with FIGS. 1-2) stored in memory (e.g., storage 508). Specifically, control circuitry 504 may be instructed by the system to perform the functions discussed above and below. In some implementations, processing or actions performed by control circuitry 504 may be based on instructions received from the system.

In client/server-based embodiments, control circuitry 504 may include communications circuitry suitable for communicating with a server or other networks or servers. The system may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 5, the instructions may be stored in storage 508, and executed by control circuitry 504 of a user equipment 500.

In some embodiments, the application may be a client/server application where only the client application resides on user equipment 500, and a server application resides on an external server (e.g., server 604 and/or media content source 602). For example, the application may be implemented partially as a client application on control circuitry 504 of user equipment 500 and partially on server 604 as a server application running on control circuitry 611. Server 604 may be a part of a local area network with one or more of user equipment 500, 501 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 604 and/or an edge computing device), referred to as “the cloud.” User equipment 500 may be a cloud client that relies on the cloud computing capabilities from server 604 to generate personalized engagement options in a VR environment.

Control circuitry 504 may include communications circuitry suitable for communicating with a server, edge computing systems and devices, a table or database server, or other networks or servers. The instructions for carrying out the above-mentioned functionality may be stored on a server (which is described in more detail in connection with FIG. 6).

Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 6). In addition, communications circuitry may include circuitry that enables peer-to-peer communication of user equipment, or communication of user equipment in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 508 may be used to store various types of content described herein as well as application data described above. Nonvolatile memory may also be used (e.g., to launch a boot-up routine and other instructions). Cloud-based storage, described in relation to FIG. 5, may be used to supplement storage 508 or instead of storage 508. Non-transitory memory may store instructions that, when executed by control circuitry, I/O circuitry, any other suitable circuitry or combination thereof, executes functions of an application as described above.

Control circuitry 504 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 504 may also include scaler circuitry for upconverting and downconverting content into the preferred output format of user equipment 500. Control circuitry 504 may also include digital-to-analog converter circuitry and analog-to-digital converter circuitry for converting between digital and analog signals. The tuning and encoding circuitry may be used by user equipment 500, 501 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 508 is provided as a separate device from user equipment 500, the tuning and encoding circuitry (including multiple tuners) may be associated with storage 508.

Control circuitry 504 may receive instruction from a user by way of user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of user equipment 500 and user equipment 501. For example, display 512 may be a touchscreen or touch-sensitive display. In such circumstances, user input interface 510 may be integrated with or combined with display 512. In some embodiments, user input interface 510 includes a remote-control device having one or more microphones, buttons, keypads, any other components configured to receive user input or combinations thereof. For example, user input interface 510 may include a handheld remote-control device having an alphanumeric keypad and option buttons. In a further example, user input interface 510 may include a handheld remote-control device having a microphone and control circuitry configured to receive and identify voice commands and transmit information to smart mirror 515.

Audio output equipment 514 may be integrated with or combined with display 512. Display 512 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 512. Audio output equipment 514 may be provided as integrated with other elements of each one of user equipment 500 and user equipment 501 or may be stand-alone units. An audio component of videos and other content displayed on display 512 may be played through speakers (or headphones) of audio output equipment 514. In some embodiments, audio may be distributed to a receiver (not shown), which processes and outputs the audio via speakers of audio output equipment 514. In some embodiments, for example, control circuitry 504 is configured to provide audio cues to a user, or other audio feedback to a user, using speakers of audio output equipment 514. There may be a separate microphone 516 or audio output equipment 514 may include a microphone configured to receive audio input such as voice commands or speech. For example, a user may speak letters or words that are received by the microphone and converted to text by control circuitry 504. In a further example, a user may voice commands that are received by a microphone and recognized by control circuitry 504. Camera 518 may be any suitable video camera integrated with the equipment or externally connected. Camera 518 may be a digital camera comprising a charge-coupled device (CCD) and/or a complementary metal-oxide semiconductor (CMOS) image sensor. Camera 518 may be an analog camera that converts to digital images via a video card.

The application may be implemented using any suitable architecture. For example, it may be a stand-alone application wholly implemented on each one of user equipment 500 and user equipment 501. In such an approach, instructions of the application may be stored locally (e.g., in storage 508), and data for use by the application is downloaded on a periodic basis (e.g., from an out-of-band feed, from an internet resource, or using another suitable approach). Control circuitry 504 may retrieve instructions of the application from storage 508 and process the instructions to provide video conferencing functionality and generate any of the displays discussed herein. Based on the processed instructions, control circuitry 504 may determine what action to perform when input is received from user input interface 510. For example, movement of a cursor on a display up/down may be indicated by the processed instructions when user input interface 510 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 504 may allow a user to provide user profile information or may automatically compile user profile information. For example, control circuitry 504 may access and monitor network data, video data, audio data, processing data, content consumption data, and/or any other suitable data being accessed by a user (e.g., user 102 of FIG. 1). Control circuitry 504 may obtain all or part of other user profiles that are related to a particular user (e.g., via social media networks), and/or obtain information about the user from other sources that control circuitry 504 may access. As a result, a user can be provided with a unified experience across the user's different devices.

In some embodiments, the application is a client/server-based application. Data for use by a thick or thin client implemented on each one of user equipment 500 and user equipment 501 may be retrieved on demand by issuing requests to a server remote to each one of user equipment 500 and user equipment 501. For example, the remote server may store the instructions for the application in a storage device. The remote server may process the stored instructions using circuitry (e.g., control circuitry 504) and generate the displays discussed above and below. The client device may receive the displays generated by the remote server and may display the content of the displays locally on user equipment 500. This way, the processing of the instructions is performed remotely by the server while the resulting displays (e.g., that may include text, a keyboard, or other visuals) are provided locally on user equipment 500. User equipment 500 may receive inputs from the user via user input interface 510 and transmit those inputs to the remote server for processing and generating the corresponding displays. For example, user equipment 500 may transmit a communication to the remote server indicating that an up/down button was selected via user input interface 510. The remote server may process instructions in accordance with that input and generate a display of the application corresponding to the input (e.g., a display that moves a cursor up/down). The generated display is then transmitted to user equipment 500 for presentation to the user.

In some embodiments, the application may be downloaded and interpreted or otherwise run by an interpreter or virtual machine (run by control circuitry 504). In some embodiments, the application may be encoded in the ETV Binary Interchange Format (EBIF), received by control circuitry 504 as part of a suitable feed, and interpreted by a user agent running on control circuitry 504. For example, the application may be an EBIF application. In some embodiments, the application may be defined by a series of JAVA-based files that are received and run by a local virtual machine or other suitable middleware executed by control circuitry 504. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 6, user equipment 606, 607, 608, 610 (which may correspond to user equipment, e.g., user device 102 of FIG. 1) may be coupled to communication network 609. Communication network 609 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 609) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 6 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 609.

System 600 may comprise media content source 602, one or more servers 604, and/or one or more edge computing devices. In some embodiments, the application may be executed at one or more of control circuitry 611 of server 604 (and/or control circuitry of user equipment 606, 607, 608, 610 and/or control circuitry of one or more edge computing devices). In some embodiments, the media content source and/or server 604 may be configured to host or otherwise facilitate video communication sessions between user equipment 606, 607, 608, 610 and/or any other suitable user equipment, and/or host or otherwise be in communication (e.g., over communication network 609) with one or more social network services.

In some embodiments, server 604 may include control circuitry 611 and storage 614 (e.g., RAM, ROM, Hard Disk, Removable Disk, etc.). Storage 614 may store one or more databases. Server 604 may also include an I/O path 612. In some embodiments, I/O path 612 is an I/O circuitry. I/O circuitry may be a NIC card, audio output device, mouse, keyboard card, any other suitable I/O circuitry device or combination thereof. I/O path 612 may provide video conferencing data, device information, or other data, over a local area network (LAN) or wide area network (WAN), and/or other content and data to control circuitry 611, which may include processing circuitry, and storage 614. Control circuitry 611 may be used to send and receive commands, requests, and other suitable data using I/O path 612, which may comprise I/O circuitry. I/O path 612 may connect control circuitry 611 to one or more communications paths.

Control circuitry 611 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 611 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 611 executes instructions for an emulation system application stored in memory (e.g., the storage 614). Memory may be an electronic storage device provided as storage 614 that is part of control circuitry 611. Memory may store instruction to run the application.

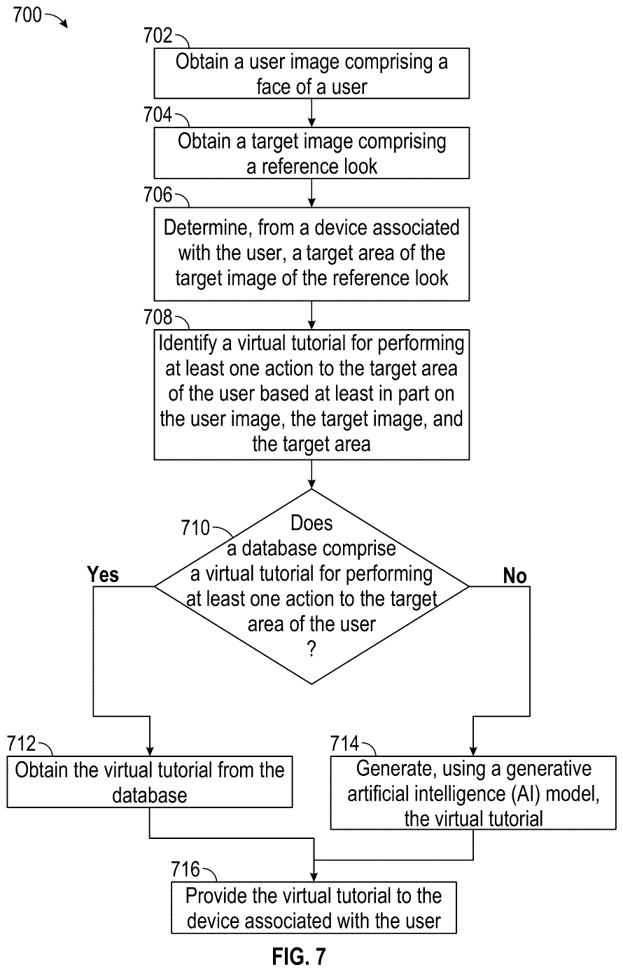

FIG. 7 is a flowchart of a detailed illustrative process for providing computer-assisted guidance, e.g., a virtual tutorial or instructions, to aid a user in performing a task, in accordance with some embodiments of this disclosure. In various embodiments, the individual steps of process 700 may be implemented by one or more components of the devices, methods, and systems of FIG. 1 and FIGS. 5-6, and may be performed in combination with any of the other processes and aspects described herein. Although the present disclosure may describe certain steps of process 700 (and of other processes described herein) as being implemented by certain components of the devices, methods, and systems of FIG. 1 and FIGS. 5-6, this is for purposes of illustration only, and it should be understood that other components of the devices, methods, and systems of FIGS. 2-4 and FIG. 8 may implement those steps instead.

In some embodiments, at 702, control circuitry (e.g., control circuitry 504 of FIG. 5 and/or control circuitry 611 of FIG. 6) obtains a user image (e.g., user image 104 of FIG. 1) comprising a face of a user (e.g., user 102 of FIG. 1). Control circuitry may obtain user image 104 via a device (e.g., device 100) associated with user 102 such as a smart mirror, a camera of a smartphone, any other suitable electronic device, or any combination thereof. In some implementations, at 704, control circuitry obtains a target image comprising a reference look. Control circuitry may obtain target image 106 based on a user input received from user 102 at device 100. As another example, control circuitry may obtain target image 106 from a user input from a second device associated with user 102 (e.g., via a smartphone or tablet running the application using the system).

In some embodiments, at 706, control circuitry determines, from device 100 associated with user 102, a target area of the target image of the reference look. In some implementations, control circuitry receives a selection of the target area from a user input. In some embodiments, control circuitry determines the target area by determining at least one visual difference between user image 104 and target image 106 comprising the reference look. In some embodiments, no target area may be specified by the user or requested by control circuitry, and in such a circumstance control circuitry may assume that user 102 desires to have their whole face resemble the face in target image 106 in its entirety. In some implementations, control circuitry may determine the target area of target image 106 based on an inference of a famous trait of target image 106 (e.g., Angelina Jolie's lips are her famous trait, and user 102 likely wants to emulate them). In some embodiments, control circuitry determines the target area based on user preferences and/or user history. For example, user 102 has selected “Lips” in the past while using the makeup application.

In some implementations, at 708, control circuitry identifies a virtual tutorial (e.g., virtual tutorial 138 of FIG. 1) for performing at least one action to the target area of the user based at least in part on the user image, the target image, and the target area. Virtual tutorial 138 may comprise instructions that, when followed by a user (e.g., user 102 applying makeup to their own face or other body part based on the instructions in the virtual tutorial), cause the user to achieve the look of the target area of target image 106. In some implementations, the virtual tutorial comprises video instruction, image instruction, textual instruction, auditory instruction, any other suitable instruction, or any suitable combination thereof. In some embodiments, virtual tutorial 138 comprises one or more instructions that utilize one or more cosmetic products of a plurality of cosmetic products available to user 102.

In some embodiments, at 710, control circuitry determines whether a database (e.g., database server 110) comprises a virtual tutorial for performing at least one action to the target area of the user. If control circuitry determines that a database comprises a virtual tutorial for performing at least one action to the target area of the user, control circuitry may proceed to 712. In some implementations, at 712, control circuitry obtains the virtual tutorial from the database. Control circuitry may obtain at least a portion of virtual tutorial 138 from database server 110 and/or any other database in communication with database server 110. In some embodiments, database server 110 may be indexed based on, e.g., demographics, different regions of the face, keyword, and/or any other suitable data. If control circuitry determines that a database does not comprise a virtual tutorial for performing at least one action to the target area of the user, control circuitry may proceed to 714.

In some embodiments, at 714, control circuitry generates, using a generative AI model, the virtual tutorial. Control circuitry may use the generative AI model to modify virtual tutorial 138 to comprise the face of user 102 (e.g., customized virtual tutorial 136 and/or goal image 140 of FIG. 1). In some embodiments, customized virtual tutorial 136 corresponds to virtual tutorial 138. In some implementations, control circuitry may identify and retrieve at least one instruction and/or at least one portion of an instruction from database server 110 and use a machine learning model and/or the generating AI model (e.g., machine learning model 130) to generate the virtual tutorial. In some embodiments, control circuitry may use target image 106 to determine the proper product(s) required or recommended to achieve the target makeup look. Such product(s) can be determined using image analysis and color and/or texture determination, and/or any other suitable techniques, to obtain then find the available product(s) from a makeup provider database using the data determined from the analysis

In some implementations, at 716, control circuitry provides the virtual tutorial to the device associated with the user. For example, control circuitry may generate for simultaneous display, on an interface of device 100 associated with user 102, user image 104 comprising the face of user 102, the target image 106 comprising the reference look, virtual tutorial 138, customized goal image 140, and/or advertisement 142, and/or any other suitable content. In some embodiments, control circuitry provides a plurality of virtual tutorials to the device associated with the user. In some embodiments, control circuitry dynamically updates virtual tutorial 138 as user 102 performs the at least one action to the target area. For example, if control circuitry detects that user 102 is deviating from target image 106, control circuitry may provide updated instructions to better visually conform user image 104 to target image 106. Control circuitry may detect that user 102 is deviating from virtual tutorial 138 using a camera of device 100, a camera of a second device associated with user 100, any other suitable detection method, or any suitable combination thereof.

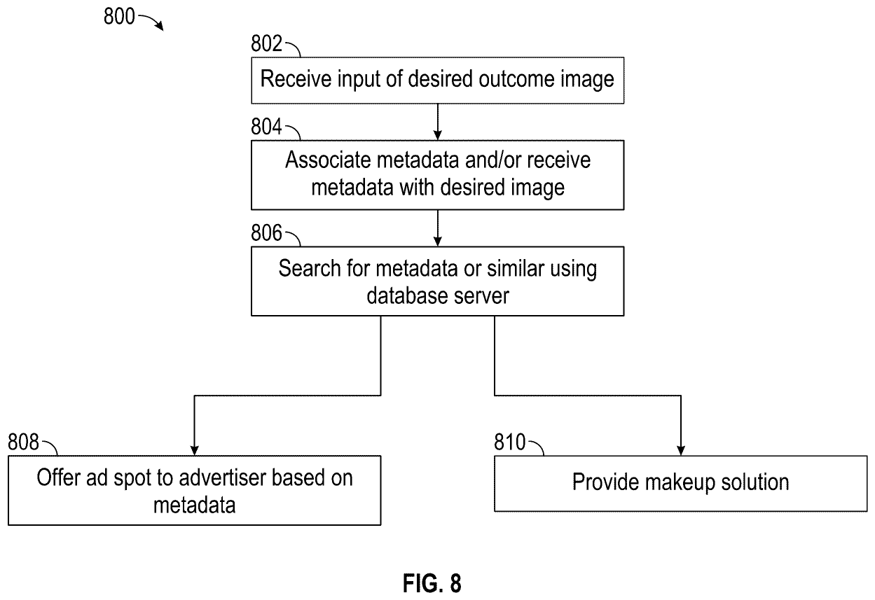

FIG. 8 is a flowchart of a detailed illustrative process for providing a makeup solution, in accordance with some embodiments of this disclosure. In various embodiments, the individual steps of process 800 may be implemented by one or more components of the devices, methods, and systems of FIG. 1 and FIGS. 5-6, and may be performed in combination with any of the other processes and aspects described herein. Although the present disclosure may describe certain steps of process 800 (and of other processes described herein) as being implemented by certain components of the devices, methods, and systems of FIG. 1 and FIGS. 5-6, this is for purposes of illustration only, and it should be understood that other components of the devices, methods, and systems of FIGS. 2-4 and FIG. 7 may implement those steps instead.

In some embodiments, at 802, control circuitry (e.g., control circuitry 504 of FIG. 5 and/or control circuitry 611 of FIG. 6) receives input of a desired outcome image. In some implementations, at 804, control circuitry associates metadata and/or receives metadata with the desired image. For example, control circuitry associates metadata (e.g., a target area as described in connection with FIG. 1) with a desired image of Angelina Jolie (e.g., target image 106 of FIG. 1). In some embodiments, control circuitry determines the target area by determining at least one visual difference between user image 104 and target image 106 comprising the reference look. In some embodiments, no target area may be specified for the user or requested by control circuitry, and in such a circumstance control circuitry may determine that user 102 desires to have their whole face resemble the face in target image 106 in its entirety. In some implementations, control circuitry may determine the target area of target image 106 based on an inference of a famous trait of target image 106 (e.g., Angelina Jolie's lips are her famous trait, and user 102 likely wants to emulate them). In some embodiments, control circuitry determines the target area based on user preferences and/or user history. For example, user 102 has selected “Lips” in the past while using the makeup application.

In some embodiments, at 806, control circuitry searches for metadata or similar using a database server (e.g., database server 110 of FIG. 1). For example, control circuitry may query database server 110 to identify identifiers of products, tutorials, and/or instructions associated with “lips,” “Angelina Jolie,” etc. In some embodiments, control circuitry may determine the proper product(s) required or recommended to achieve target image 106. Such product(s) can be determined using image analysis and color and/or texture determination, and/or any other suitable techniques, to obtain then find the available product(s) from a makeup provider database using the data determined from the analysis. In some implementations, after 806, control circuitry proceeds to 808. In some embodiments, at 808, control circuitry offers an advertisement spot to an advertiser based on the metadata. For example, control circuitry may provide an advertisement (e.g., advertisement 306 and/or advertisement 308 of FIG. 3) at device 100. In some implementations, after 806, control circuitry alternatively or in conjunction proceeds to 810. In some embodiments, at 810, control circuitry provides a makeup solution (e.g., virtual tutorial of FIG. 1). For example, control circuitry may generate for simultaneous display, on an interface of device 100 associated with user 102, user image 104 comprising the face of user 102, the target image 106 comprising the reference look, virtual tutorial 138, customized goal image 140, and/or advertisement 142, and/or any other suitable content. In some embodiments, control circuitry provides a plurality of virtual tutorials to the device associated with the user.

In some embodiments, the disclosed systems and methods may receive a face image, receive a desired makeup look image, receive a target makeup area focus, determine a makeup solution based on AI and database data, and present the makeup solution on a digital mirror or screen by providing an area of particular makeup application within the target makeup area focus. In some embodiments, the presenting the makeup solution includes displaying product information associated with the area of particular makeup application. In some embodiments, the determining makeup solutions includes retrieving information from a plurality of makeup application source information. In some embodiments, the determining the makeup solution includes retrieving information from a plurality of makeup application source information, and the method further includes receiving feedback as to whether the makeup solution requires an additional iteration. In some embodiments, the determining makeup solution includes retrieving information from a plurality of makeup application source information, and the method further includes receiving feedback as to whether the makeup solution requires an additional iteration and storing the result.

In some embodiments, determining a makeup solution based on AI and database data includes searching metadata associated with the makeup solution. In some embodiments, determining a makeup solution based on AI and database data includes searching metadata associated with the makeup solution using a statistical model and AI feedback that indicate a probability of desired outcome for matching the desired makeup look image based on the target makeup area focus. In some embodiments, determining a makeup solution based on AI database data includes searching metadata associated with the makeup solution using a statistical model and AI feedback that indicate a probability of desired outcome for matching the desired makeup look image based on the target makeup area focus, wherein the desired makeup area focus is lips, eyes, or bone structure shading. In some embodiments, an advertisement spot is offered based on the metadata. The embodiments described herein may also be applied to clothing styles, target looks, or hairstyles.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
obtaining a user image comprising a face of a user;
obtaining a target image comprising a reference look;
determining, from a device associated with the user, a target area of the target image of the reference look;
identifying a virtual tutorial for performing at least one action to the target area of the user, wherein the identifying the virtual tutorial is based at least in part on the user image, the target image, and the target area; and
providing the virtual tutorial to the device associated with the user.

2. The method of claim 1, wherein the identifying the virtual tutorial further comprises:
providing data indicative of the user image, the target image, and the target area as input to a trained machine learning model; and
receiving the virtual tutorial for performing the at least one action to the target area of the user from the trained machine learning model.

3. The method of claim 2, wherein the identifying the virtual tutorial further comprises:
obtaining, based at least in part on the target image, at least one instruction from a database, wherein data indicative of the at least one instruction is provided as input to the trained machine learning model with the data indicative of the user image, the target image, and the target area.

4. The method of claim 3, wherein the at least one instruction is a cosmetic tutorial video depicting cosmetics being applied to a face other than the face of the user, and the virtual tutorial depicts the cosmetics being applied to the face of the user.

5. The method of claim 3, wherein at least a portion of the virtual tutorial comprises a generative artificial intelligence (AI) video.

6. The method of claim 1, wherein the virtual tutorial comprises one or more of video instruction, image instruction, textual instruction, auditory instruction, or product recommendation.

7. The method of claim 1, wherein the target area is a first target area, wherein the virtual tutorial is a first virtual tutorial, the method further comprising:
receiving a selection, from the device associated with the user, of a second target area of the target image of the reference look;
identifying a second virtual tutorial for performing at least one action to the second target area of the user, wherein the identifying the second virtual tutorial is based at least in part on the second target area; and
providing the second virtual tutorial to the device associated with the user.

8. The method of claim 1, wherein the virtual tutorial for performing the at least one action to the target area of the user comprises one or more instructions that utilize one or more cosmetic products of a plurality of cosmetic products available to the user.

9. The method of claim 8, further comprising:
determining that the one or more instructions of the virtual tutorial for performing the at least one action to the target area of the user requires at least one cosmetic product that is not included in the plurality of cosmetic products available to the user; and
based at least in part on the determining, providing a recommendation associated with the user to purchase the at least one cosmetic product.

10. The method of claim 1, wherein the device associated with the user is one of a smart mirror, another electronic device, or a combination thereof.

11. The method of claim 1, further comprising:
aligning facial features of the face of the user with facial features of the reference look in the target image; and
based at least in part on the aligning, generating for display at the device a visual overlay of guidelines indicating where to perform the at least one action on the face of the user.

12. The method of claim 1, further comprising:
generating for simultaneous display, on an interface of the device associated with the user, the user image comprising the face of the user, the target image comprising the reference look, and the virtual tutorial.

13. The method of claim 1, wherein the virtual tutorial comprises a zoomed-in view of the target area on the face of the user.

14. The method of claim 1, wherein the virtual tutorial is a first virtual tutorial, wherein the at least one action is a first action, the method further comprising:
determining at least one visual difference between the user image comprising the face of the user and the target image comprising a reference look; and
wherein the target area is identified based at least in part on the at least one visual difference.

15. The method of claim 1, further comprising:
determining that the user, applying cosmetics, is deviating from guidance in the virtual tutorial in relation to the target area; and
updating the guidance of the virtual tutorial for at least one other area of the face of the user, based at least in part on the determining.

16. A system comprising:
input/output circuitry configured to:
obtain a user image comprising a face of a user;
obtain a target image comprising a reference look;
control circuitry configured to:
determine, from a device associated with the user, a target area of the target image of the reference look;
identify a virtual tutorial for performing at least one action to the target area of the user, wherein the identifying the virtual tutorial is based at least in part on the user image, the target image, and the target area; and
provide the virtual tutorial to the device associated with the user.

17. The system of claim 16, wherein the control circuitry is further configured to identify the virtual tutorial by:
providing data indicative of the user image, the target image, and the target area as input to a trained machine learning model; and
receiving the virtual tutorial for performing the at least one action to the target area of the user from the trained machine learning model.

18. The system of claim 17, wherein the control circuitry is further configured to identify the virtual tutorial by:
obtaining, based at least in part on the target image, at least one instruction from a database, wherein data indicative of the at least one instruction is provided as input to the trained machine learning model with the data indicative of the user image, the target image, and the target area.

19. The system of claim 18, wherein the at least one instruction is a cosmetic tutorial video depicting cosmetics being applied to a face other than the face of the user, and the virtual tutorial depicts the cosmetics being applied to the face of the user.

20. The system of claim 18, wherein at least a portion of the virtual tutorial comprises a generative artificial intelligence (AI) video.

21-75. (canceled)
